(19) United States
(12) Patent Application Publication
(10) Pub. No.: US 2026/0021749 A1
(43) Pub. Date: Jan. 22, 2026

(54) MOTOR ADAPTER AND ADJUSTMENT DEVICE

(71) Applicant: Adient US LLC, Plymouth, MI (US)

(72) Inventors: Ingo QUAST, Düsseldorf (DE); Erik SPRENGER, Wermelskirchen (DE)

(21) Appl. No.: 19/270,618

(22) Filed: Jul. 16, 2025

(30) Foreign Application Priority Data
Jul. 16, 2024 (DE) 10 2024 206 692.3
Oct. 14, 2024 (DE) 10 2024 209 960.0

(51) Int. Cl. B60N 2/02

(52) U.S. Cl. CPC B60N 2/02258; B60N 2/02253

(57) ABSTRACT

A motor adapter may have on the one hand, a motor mount and, on the other hand, a coupling mount. The motor mount may be configured as a first mount opening that is designed to receive a motor and to hold the motor releasably in a form-fit and/or force-fit manner. The coupling mount adjoins the motor mount and is configured as a second mount opening which may be designed to receive a coupling and to hold it releasably in a form-fit and/or force-fit manner. The coupling may be joined directly to the motor.

### FIELD

The invention relates to a motor adapter for a motor of an adjustment device of a vehicle seat or a component of the vehicle seat, an adjustment device, and a vehicle seat.

### BACKGROUND

Motor-actuatable adjustment devices for a vehicle seat or a component of the vehicle seat are generally known in the art. For example, motor-actuatable adjustment devices exist in the form of an armrest adjustment mechanism for an armrest, a backrest adjustment mechanism for a backrest, and a longitudinal adjustment mechanism for the vehicle seat. A motor adapter or a motor bridge can be provided for connecting and mounting the motor to the respective adjustment device.

The invention is based on the object of improving a motor adapter of the kind mentioned above, in particular to improve its vibration and tolerance characteristics, to provide an adjustment device with an improved motor connection, and to provide a corresponding vehicle seat.

### SUMMARY

The first-mentioned object is achieved according to the invention by a motor adapter having the features of claim 1.

The motor adapter according to the invention is provided for a motor, in particular a so-called micromotor, and comprises, on the one hand, a motor mount and, on the other hand, a coupling mount, wherein the motor mount is configured as a first mount opening which is designed to receive the motor and to hold it releasably in a form-fit and/or force-fit manner, and wherein the coupling mount adjoins the motor mount and is configured as a second mount opening which is designed to receive a coupling, in particular designed as a compensation coupling, and to hold it releasably in a form-fit and/or force-fit manner, and wherein the coupling is directly joined to the motor, in particular by a form-fit, force-fit, and/or a material bond, for example in a press-fittable or press-fitted, interference-fittable or interference-fitted, manner, or the like.

The motor adapter is designed as a separate adapter component which comprises both a motor mount and a coupling mount that adjoin one another. The motor adapter allows a releasable and form-fitted and/or force-fitted connection of a coupling directly to the motor via two adjacent mounts—the motor mount and the coupling mount—that adjoins the motor mount.

The claimed motor adapter allows for a secure and releasable connection between the motor and the coupling in a compact and integrated manner. This is achieved in particular by providing the motor mount and the coupling mount in the motor adapter as adjacent mount openings, wherein each mount opening is configured in such a manner that it can hold its respective components (motor and coupling) in a form-fit and/or force-fit manner, wherein the coupling is directly joined to the motor.

An arrangement of this kind facilitates simple assembly and disassembly, ensures reliable torque transmission, and allows for easy replacement or maintenance of the motor or the coupling without requiring complex tools or procedures.

The second-mentioned object is achieved according to the invention by an adjustment device according to claim 10 comprising the motor adapter previously described.

The third-mentioned object is achieved according to the invention by a vehicle seat according to claim 11 comprising the adjustment device previously described with the motor adapter described above.

Since the coupling, in particular the compensation coupling, is directly joined to the motor, in particular to its motor shaft, possible component tolerances, in particular axial offsets and also radial offsets, can be compensated for in a simple manner. In the prior art, so-called flex shafts are used for this purpose. Furthermore, because the motor is designed as a direct drive, it can also be used in the limited installation space. Furthermore, the direct coupling also enables acoustic decoupling in a simple way.

The motor can, for example, be designed as a geared motor. The motor comprises an output shaft as the motor shaft. The coupling is provided for coupling the motor to the transmission.

In this case, the coupling may, for example, be directly joined to a motor shaft of the motor. For example, the coupling may be directly joined to the motor shaft, in particular by a form-fit, force-fit, and/or a material bond, for example in a pluggable/plugged-in, press-fittable/press-fitted, interference-fittable/interference-fitted, manner.

For example, the coupling, in particular the compensation coupling, can be designed as a multi-part component. Alternatively, the coupling can be formed in one piece. The coupling is designed as a connection between the motor and the transmission. The coupling primarily serves to transmit the motor torque to the transmission. The coupling, designed as the compensation coupling, is in particular configured to compensate for possible component tolerances, in particular axial misalignments between the motor shaft and the transmission input, and/or radial misalignments, in a simple manner.

On one side, the coupling is directly coupled to the motor and, on the other side, to the transmission, for example for an adjustment device, in particular an armrest adjustment mechanism, a seat adjustment device, or the like. In particular, the coupling may comprise a coupling adapter and a coupling element.

The coupling adapter and the coupling element are, for example, fixedly, in particular rotationally fixedly, connected to one another. For example, the coupling element can be directly joined to the coupling adapter. In particular, the coupling adapter is directly joined to the motor shaft, in particular by a form-fit, force-fit, and/or a material bond, for example plugged-in, press-fitted, interference-fitted, and/or compression-fitted.

Furthermore, the motor and the coupling may be preassembled or preassemblable as a mounting assembly.

Advantageous embodiments, which may be used individually or in combination with one another, are the subject matter of the dependent claims.

### DESCRIPTION OF THE FIGURES

The invention is explained in greater detail below with the help of advantageous exemplary embodiments illustrated in the figures. However, the invention is not limited to these exemplary embodiments. In the drawings:

FIG. 1: shows a schematic representation of a vehicle seat with a longitudinal adjustment mechanism according to the prior art,

FIG. 2: shows a perspective view of a motor adapter for a motor of an adjustment device,

FIG. 3: shows a perspective view of a motor output with an attached coupling,

FIG. 4: shows a sectional view of the motor adapter with mounted motor and coupling joined directly to the motor,

FIG. 5: shows a perspective view of the motor adapter with motor and its connection to the adjustment device,

FIG. 6: shows a perspective view of the connection of the motor to the adjustment device without a motor adapter but with an attached coupling,

FIG. 7: shows a further perspective view of the connection of the motor to the adjustment device with motor adapter, viewed from above onto the adjustment device,

FIG. 8: shows a further perspective view of the connection of the motor to the adjustment device with motor adapter, viewed from below onto the adjustment device as part of an adjustable armrest,

FIG. 9: shows a schematic exploded view of the motor and the coupling, and

FIG. 10: shows a schematic exploded view of the motor with joined coupling adapter and the coupling element.

### DETAILED DESCRIPTION

Parts that correspond to one another are identified using the same reference signs in all figures.

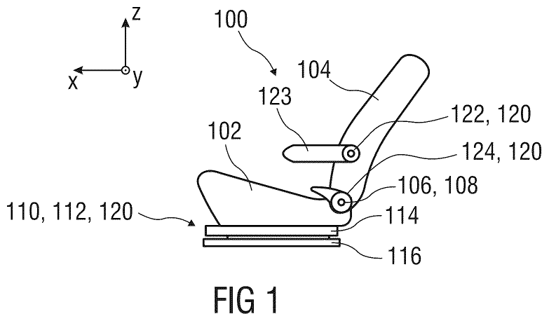

A vehicle seat 100 schematically illustrated in FIG. 1 as prior art is described below using three spatial directions that are perpendicular to one another. In the case of a vehicle seat 100 installed in a vehicle, a longitudinal direction x runs substantially horizontally and preferably parallel to a vehicle longitudinal direction which corresponds to the normal direction of travel of the vehicle. A transverse direction y, which is perpendicular to the longitudinal direction x, is also aligned horizontally in the vehicle and runs parallel to a vehicle transverse axis. A vertical direction z runs perpendicular to both the longitudinal direction x and the transverse direction y. In the case of a vehicle seat 100 installed in the vehicle, the vertical direction z preferably runs parallel to a vertical axis of the vehicle.

The positional and directional indications used, such as front, rear, top, and bottom, for example, refer to the viewing direction of an occupant seated in the vehicle seat 100 in a normal seating position, wherein the vehicle seat 100 is installed in the vehicle in a usage position suitable for transporting persons, with an upright backrest 104 and oriented as usual in the direction of travel. However, the vehicle seat 100 can also be installed or moved in a different orientation, for example transverse to the direction of travel. Unless otherwise described the vehicle seat 100 is constructed to be mirror-symmetrical with respect to a plane perpendicular to the transverse direction y.

The backrest 104 can be pivotally arranged on a seat part 102 of the vehicle seat 100. For this purpose, the vehicle seat 100 can optionally comprise a fitting 106, in particular an adjustment fitting, rotary fitting, locking fitting, or rocker fitting.

The positional and directional indications used, such as radial, axial, and circumferential, refer to a rotational axis 108 of the fitting 106. Radial means perpendicular to the rotational axis 108. Axial means in the direction of or parallel to the rotational axis 108.

The vehicle seat 100 may optionally comprise a longitudinal adjustment device 110. The longitudinal adjustment device 110 comprises, for example, a rail arrangement 112 with a first rail element 114 and a second rail element 116. The first rail element 114 is adjustable relative to the second rail element 116 in the longitudinal direction x. The first rail element 114 is fastened to the seat part 102. The second rail element 116 is fastened to a structural element of a vehicle, for example to a vehicle floor.

For greater clarity, the first rail element 114 is referred to in the following description as the upper rail 114. This upper rail 114 (also called the running rail or carriage) is assigned to the vehicle seat 100 and configured to support said vehicle seat 100.

The second rail element 116 is hereafter referred to as the lower rail 116. The lower rail 116 is fixed and, for example, connected to the floor of a vehicle.

The longitudinal adjustment device 110 constitutes an adjustment device 120 for the vehicle seat 100. In addition, the vehicle seat 100 may comprise another or an alternative adjustment device 120, for example an armrest adjustment device 122 for an armrest 123 and/or a backrest adjustment device 124.

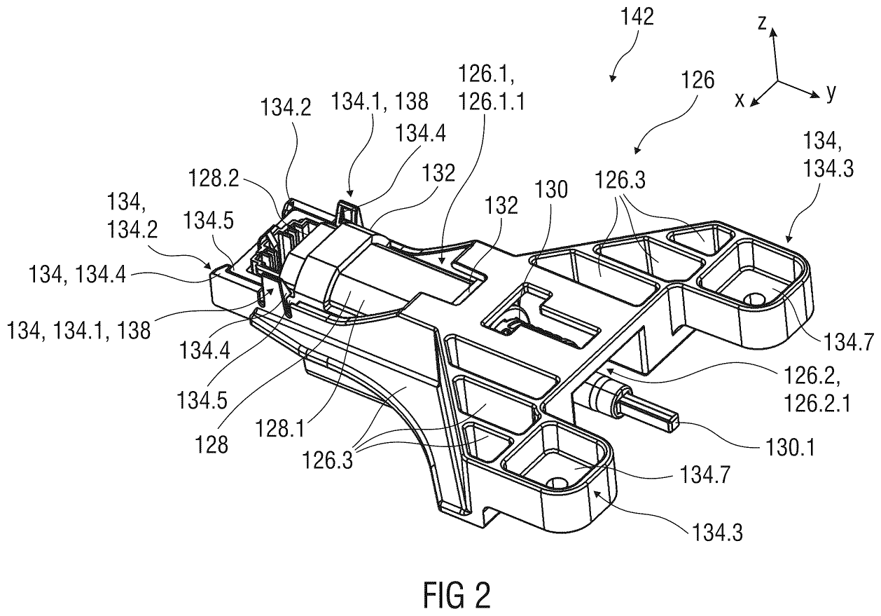

FIG. 2 shows a perspective view of a motor adapter 126 for a motor 128 of one of the adjustment devices 120 of the vehicle seat 100. The motor adapter 126 can be provided and correspondingly configured for an adjustment device 120 with a rail arrangement 112 for connecting the motor 128 to the rail arrangement 112.

The motor 128 with the motor adapter 126 can be arranged within the armrest 123 and form part of an armrest drive. This drive ensures positioning of the armrest 123, for example in the longitudinal direction x, according to the preference of an occupant or to ease access to the vehicle seat 100 or also behind the vehicle seat 100 designed as an ‘easy-entry’ seat. In this case, the motor 128 is coupled with the rail arrangement 112, which may have a spindle-type longitudinal adjustment, for example.

The motor 128 comprises a motor housing 128.1 and a motor connector 128.2 for the electrical supply and control of the motor 128. The motor 128 is designed in particular as a low-voltage motor.

However, the motor 128 with the motor adapter 126 can also be used in the longitudinal adjustment device 110 with two seat rails or upper rails 114, wherein the motor 128 is coupled with one of the two upper rails 114 and drives them both.

The motor adapter 126 comprises, on the one hand, a motor mount 126.1 and, on the other hand, a coupling mount 126.2.

The motor mount 126.1 is formed, for example, as a first, in particular elongate, mounting opening 126.1.1, which is configured to receive the motor 128 and to hold it releasably in a form-fit and/or force-fit manner.

The coupling mount 126.2 follows the motor mount 126.1 in the longitudinal extension of the motor adapter 126. The coupling mount 126.2 is designed, for example, as a second, in particular rectangular, mounting opening 126.2.1, which is configured to receive a coupling 130, in particular a compensation coupling, and to hold it releasably in a form-fit and/or force-fit manner.

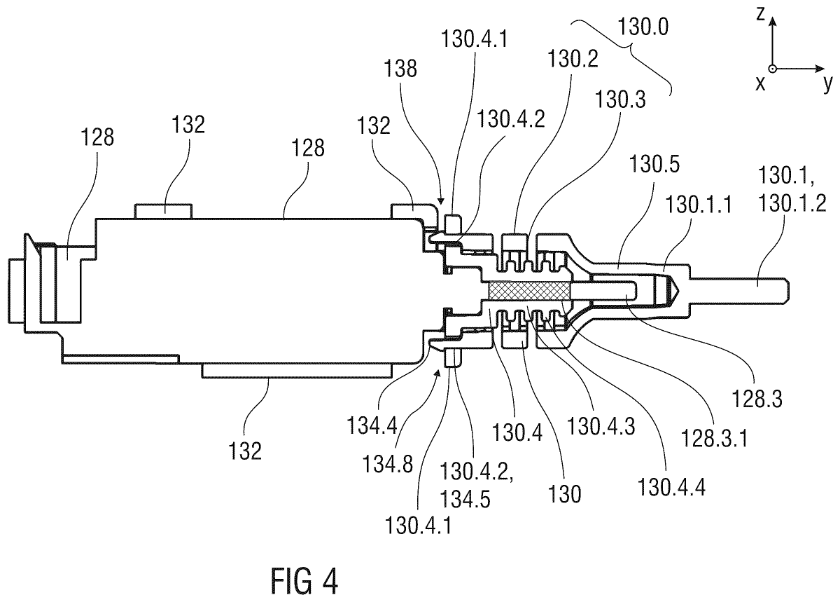

The coupling 130 is joined directly to the motor 128, in particular to its motor shaft 128.3 (shown in FIG. 4), for example with knurling, particularly in a manner that is press-fittable or press-fitted, interference-fittable or interference-fitted, or the like.

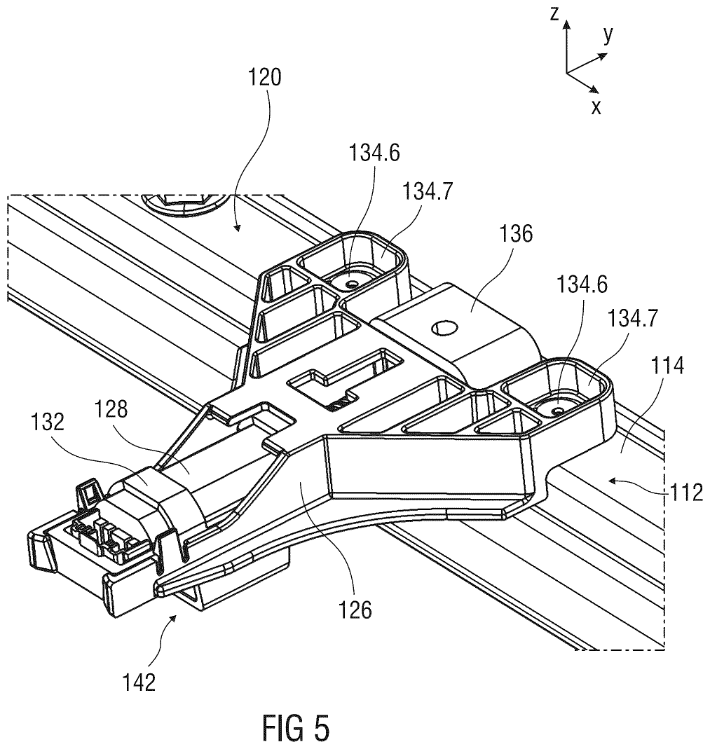

Due to the fact that the coupling 130 is joined directly to the motor 128, possible component tolerances, in particular axial offsets between the motor shaft 128.3 and the gearbox input, and also radial offsets, can be compensated for in a simple manner. The coupling 130 comprises a coupling interface 130.1 to a gearbox 136 (shown in FIG. 5) of the adjustment device 120. The coupling interface 130.1 is designed to correspond to the gearbox 136, in particular to a worm gear. For example, the coupling interface 130.1 is designed as a square profile.

The motor adapter 126 may, in addition, comprise damping sections 132. The damping sections 132 are configured to dampen vibrations of the motor 128. The damping sections 132 are particularly designed to correspond to an outer contour of the motor housing 128.1 of the motor 128. The damping sections 132 are, for example, of ring-shaped, belt-shaped, bridge-shaped, or similar, design, and are formed to lie in contact with the motor housing 128.1. The damping sections 132 may be formed separately and may be releasably attached to the motor housing 128.1. The damping sections 132 are, for example, designed as a separate molded component or a separate profile body. The damping sections 132 may also be integrally formed on the motor housing 128.1, in particular molded on.

The motor adapter 126 is designed as a profile-shaped body, for example a semi-open profile, with stiffening sections 126.3. The stiffening sections 126.3 are designed, for example, as walls, webs, ribs, or the like. The motor adapter 126 is designed, in particular, as a one-piece molded body, in particular an injection-molded part or the like. In particular, the motor adapter 126 is a functional 3D molded body with integrated motor mount 126.1, integrated coupling mount 126.2, integrated damping sections 132, and/or integrated fastening sections 134.

The damping sections 132, in particular rubber elements or other suitable dampers, are arranged in particular between the motor 128 and the motor adapter 126. The damping sections 132 are designed and configured and arranged directly on the motor 128 in such a manner that the motor 128 is completely acoustically decoupled from the motor adapter 126, and therefore acoustically damped. There is no direct contact between the motor adapter 126 and the motor 128. The damping sections 132 are arranged therebetween.

First fastening sections 134.1 are designed, for example, as releasable clip connections 138 or latch connections, comprising, for example, complementary clips and clip mounts or complementary latching hooks 134.4 and latching mounts 134.5, between the motor adapter 126 and the motor 128.

Second fastening sections 134.2 are formed, for example, as releasable clip connections 138 or latch connections, comprising, for example, complementary clips and clip mounts or complementary latching hooks 134.4 and latching mounts 134.5, between the motor adapter 126 and the motor connector 128.2.

Third fastening sections 134.3 are designed, for example, as releasable screw connections or rivet connections, comprising, for example, complementary screws and screw mounts or complementary rivets 134.6 and rivet mounts 134.7, between the motor adapter 126 and the adjustment device 120, as shown in FIG. 5.

The motor adapter 126 may be preassembled together with the motor 128 and the coupling 130 into an assembly module 142. This assembly module 142 can then be mounted as a whole onto the adjustment device 120.

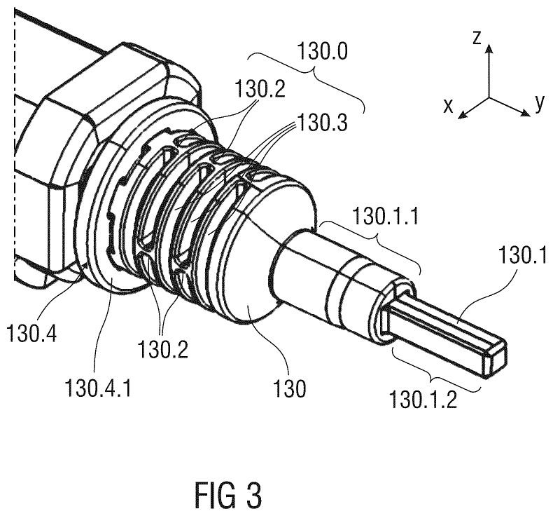

FIG. 3 shows a perspective view of a motor output with a joined coupling 130 having a coupling interface 130.1 for connection and coupling to the gearbox 136 (shown in FIG. 5).

The coupling interface 130.1 has, at least in sections, a square profile as its outer shape. The coupling interface 130.1 comprises a base section 130.1.1 and a coupling section 130.1.2. The base section 130.1.1 is designed as a hollow cylinder. The coupling section 130.1.2 is designed as a square hollow profile or a solid square profile.

The coupling 130 comprises, as coupling elements 130.0, a number of ring disks 130.3, which are each connected to an adjacent ring disk 130.3 by a number of webs 130.2, in particular by two webs 130.2. The ring disks 130.3 are designed to be flexible and can compensate for tolerances.

Two webs 130.2 for connecting two ring disks 130.3 adjacent in the longitudinal direction x (on one side of a motor axis) are arranged, for example, offset by 90° relative to the two webs 130.2 for connecting another two adjacent ring disks 130.3 in the longitudinal direction x (on the opposite side along the motor axis). This allows the elasticity of the ring disks 130.3 to be used for a compensation movement. To ensure a uniform torque transmission at angular positions, the offset webs 130.2 (also referred to as web bridges) must be present in equal numbers.

In addition, a coupling adapter 130.4 may be provided. The coupling adapter 130.4 comprises an extension 130.4.1, in particular a disk-shaped or radial extension 130.4.1.

FIG. 4 shows a sectional depiction of the motor 128 with the coupling 130 fitted directly onto the motor 128 and without the motor adapter 126 (as shown in FIG. 3).

Due to the fact that the coupling 130 is fitted directly onto the motor 128, particularly onto a rigid or fixed motor shaft 128.3, possible component tolerances, particularly axial offsets and/or also radial offsets, can be compensated for in a simple manner. Furthermore, because the motor 128 is designed as a direct drive, it can also be used in the limited installation space. In this case, the elasticity of the ring disks 130.3 can be used for compensation movements, in particular axial compensation movements.

The motor shaft 128.3 may be provided with a knurled profile 128.3.1. The coupling adapter 130.4 is first press-fitted onto the motor shaft 128.3 with the knurled profile 128.3.1. It is therefore connected to the motor shaft 128.3 with a form-fit and a force-fit.

On the side facing the motor 128, the coupling adapter 130.4 has the, for example disk-shaped, extension 130.4.1, which may be provided with a number of through-openings 130.4.2. The extension 130.4.1 is arranged coaxially with the motor shaft 128.3. The extension 130.4.1 preferably comprises multiple through-openings 130.4.2 evenly distributed in a circular pattern for a clip connection 138 with the coupling 130. The clip connection 138 between the coupling 130 and the coupling adapter 130.4 forms a fourth fastening section 134.8, which is designed, for example, as a clip connection 138 or latch connection with latching hooks 134.4 and latching mounts 134.5 or similar.

By means of the clip connection 138, offsets in particular, such as axial offsets and/or radial offsets, between the motor shaft 128.3 (also referred to as the drive shaft) and the rotational axis of the gearbox 136, in particular of the worm gear inside the gearbox 136, can be compensated. The clip connection 138 provides for axial fixation and centering of the coupling 130 on the coupling adapter 130.4.

The coupling 130 forms the connection between the motor 128 and the gearbox 136 and can compensate for angular offsets, axial offsets, and/or also radial offsets. In conventional adjustment devices 120 (also referred to as adjusters), flexible shafts are commonly used; these can be dispensed with thanks to the invention. Given the small direct drive of the motor 128 within the limited installation space, a solution of this kind is particularly advantageous.

Furthermore, the coupling 130 provides additional acoustic decoupling.

To couple the coupling 130 and the coupling adapter 130.4 with radial play (i.e. play in the direction of rotation), the through-openings 130.4.2 in the coupling adapter 130.4 may be larger in circumference and/or in their dimensions than the latching hooks 134.4 or latching tabs on the coupling 130 that engage with them. This results in play. In this way, the motor 128 can initiate rotation before the coupling 130 is engaged. In this way, the motor 128 can build up a certain amount of kinetic energy, which facilitates the startup of the gearbox movement.

For example, the motor shaft 128.3 protrudes through a hollow cylindrical section 130.4.3 of the coupling adapter 130.4 and into a cavity 130.5, in particular a hollow cylinder, within the base section 130.1.1 of the coupling 130. In addition, the outer side of the hollow cylindrical section 130.4.3 of the coupling adapter 130.4 may be provided with fins 130.4.4 or rings. These fins 130.4.4 or rings serve as a rib structure to provide reinforcement. These fins 130.4.4, in particular ring-shaped fins, or rings prevent the pressing forces between the coupling adapter 130.4 and the motor shaft 128.3 from decreasing over time. These fins 130.4.4 or rings increase the cross-section and therefore the stiffness in sections, in particular in the region of contact of the fins 130.4.4 or the rings.

The lateral distance between the motor shaft 128.3 and the cylindrical surface of the cavity 130.5 is selected so that tilting of the preassembled assembly, for example, consisting of the motor 128 and coupling 130, cannot result in the destruction of the coupling elements 130.0, particularly the ring disks 130.3 and webs 130.2, as the contact between the motor shaft 128.3 and the cylindrical surface of the cavity 130.5 provides an angular limitation.

Furthermore, another kind of assembly is facilitated, since the coupling 130 can be press-fitted with high force into the gearbox 136, in particular into a mating element, for example a rectangular opening of the worm gear. In this process, the motor 128 with the preassembled coupling 130 is interference-fitted into the worm gear of the gearbox 136. The motor adapter 126 is then threaded over the motor assembly consisting of motor 128, the coupling 130 (i.e. compensation coupling), and the damping elements/damping section 132, and fixed to the upper rail 114, for example by means of rivets or screws. This is made possible because the motor shaft 128.3 can brace itself at the end face within the coupling adapter 130.4, since the flexible ring disk(s) 130.3 allow(s) this axial movement in the assembly direction. In this way, the coupling interface 130.1 can be pressed all the way into the gearbox 136, in particular into a mating interface of the worm gear.

The coupling section 130.1.2 of the coupling 130 is designed, for example, as a profile, in particular as a square profile.

FIG. 5 shows a perspective view of the motor adapter 126 with the motor 128 and its connection to the adjustment device 120, which may be preassembled as an assembly module 142.

The motor adapter 126 with the releasably arranged motor 128 may be preassembled as an assembly unit (also referred to as a preassembly module or preassembly unit).

During assembly, the motor 128 and the coupling 130 may be preassembled into a preassembly module or the motor assembly of the motor adapter 126. After the motor assembly consisting of the motor 128 with coupling 130 and coupling interface 130.1 (shown in FIG. 4) is interference-fitted into the gearbox 136, the motor adapter 126 with integrated damping sections 132 can be threaded over the motor assembly and riveted to the rail arrangement 112 using rivets 134.6 in the rivet mounts 134.7.

Alternatively, the motor 128, the coupling 130, and separately formed damping sections 132 can be preassembled as a subassembly or motor assembly. In other words, the damping sections 132 are not part of the motor adapter 126 but are designed separately and may be arranged around the motor 128. The separate damping sections 132 (also referred to as damping elements) may be applied and fixed directly to the motor 128, in particular to a motor housing 128.1, for example. By way of example, the separate damping sections 132 may be designed as separate damping rings, in particular rubber rings or the like.

FIG. 5 shows the adjustment device 120 with rail arrangement 112, with a coupled drive comprising a motor adapter 126 and motor 128. In this case, a motor 128 is configured as a miniature motor and is held in a vibration-damped manner entirely within the motor adapter 126 via the damping section 132, in particular a rubber element or rubber band. The motor 128 is coupled to the gearbox 136 of the movable seat rail or upper rail 114.

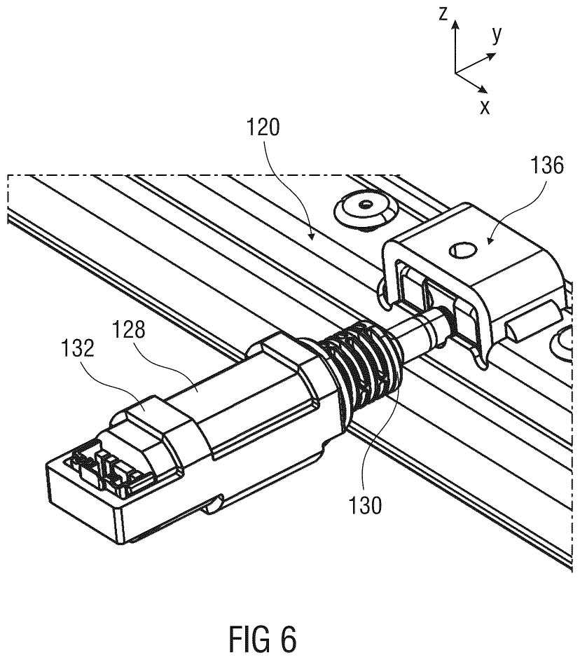

FIG. 6 shows a perspective view of the connection of the motor 128 to the adjustment device 120, in particular its gearbox 136, without the motor adapter 126, but with the joined coupling 130 and damping section 132.

The coupling is achieved via a coupling 130 (also referred to as a plastic coupling or polymer coupling) that is press-fitted directly onto the motor 128.

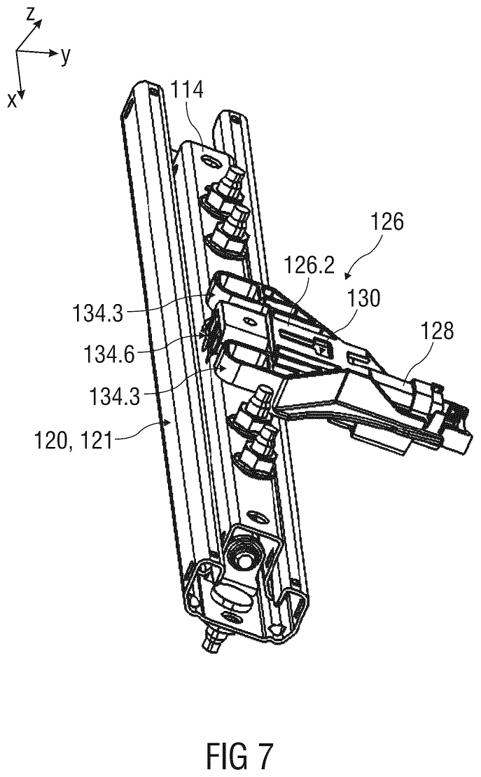

FIG. 7 shows another perspective view of the connection of the motor 128 to the adjustment device 120 with motor adapter 126 in a top view obliquely from the front and from above the adjustment device 120 configured as a longitudinal adjustment device 110.

The longitudinal adjustment device 110 may be designed, for example, for longitudinal adjustment of the armrest 123 (shown in FIG. 1) or another seat component.

The motor adapter 126 is arranged on and fastened to the upper rail 114. The motor adapter 126 has two third fastening sections 134.3 for fastening to the upper rail 114.

The gearbox 136 protrudes from the upper rail 114. The gearbox 136 is arranged between the two third fastening sections 134.3. The motor adapter 126 can be fastened to the adjustment device 120, in particular to the upper rail 114, by means of rivets 134.6.

The motor adapter 126 is fastened to the upper rail 114 in such a manner that the coupling mount 126.2, and therefore the coupling 130 arranged in the coupling mount 126.2, abuts the gearbox 136 in such a manner that the coupling interface 130.1 (shown in FIG. 2) leads directly into the gearbox 136. The gearbox 136 is in particular a worm gearbox. The coupling interface 130.1 is, in particular, a rotary journal, for example a square profile. The coupling interface 130.1 is, for example, coupled to a worm, a worm wheel, or a worm nut in the gearbox 136 in a motion-coupled or rotationally fixed manner.

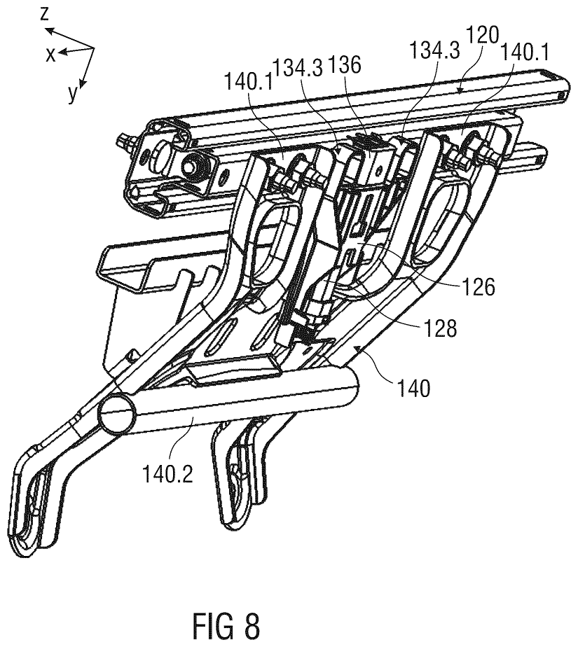

FIG. 8 shows a further perspective view of the connection of the motor 128 with motor adapter 126 to the gearbox 136 of the adjustment device 120, in a view from below of the adjustment device 120. The motor adapter 126 is fixedly connected to the adjustment device 120 via the third fastening sections 134.3, in particular riveted or screwed.

The adjustment device 120, in particular the movable upper rail 114, may in turn be coupled to a support structure 140 of the armrest 123 (shown in FIG. 1). The support structure 140 is, for example, designed as a profiled component. The support structure 140 comprises two connection interfaces 140.1, by which the support structure 140 is detachably connected to the upper rail 114 by means of screw connections. The support structure 140 may comprise reinforcement profiles 140.2, for example a reinforcement tube.

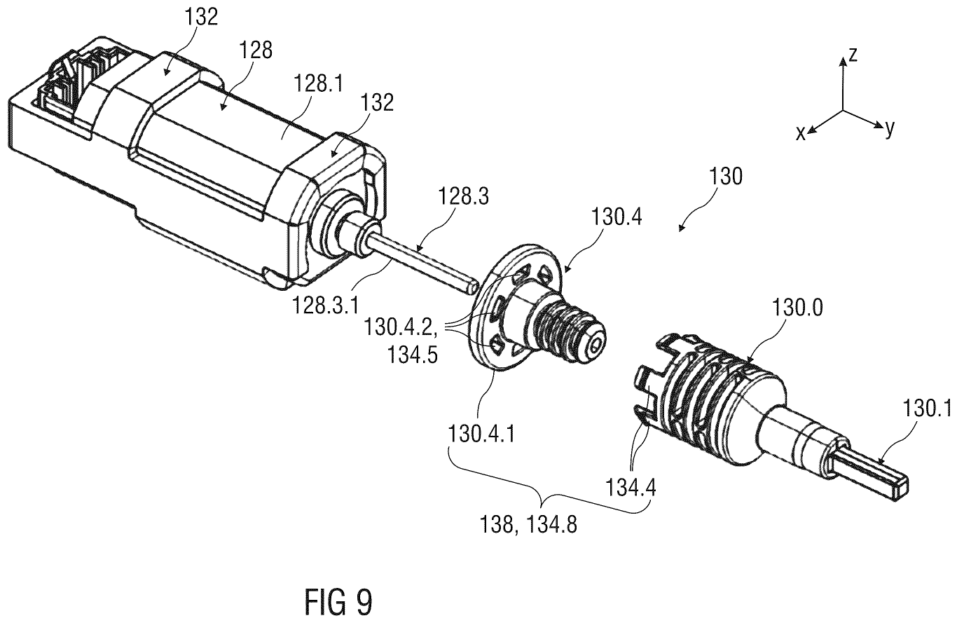

FIG. 9 shows schematically an exploded view of the motor 128 and the coupling 130.

The motor 128 is provided with the damping section/damping sections 132. As previously described, these may be designed separately or in one piece. They may be detachably fastened to the motor housing 128.1.

The motor 128 has, as an output shaft, the motor shaft 128.3, which protrudes from the motor housing 128.1. The coupling 130 comprises the previously described coupling adapter 130.4 and the coupling element 130.0, which includes the coupling interface 130.1 for the gearbox 136 (shown in FIG. 7).

On the side facing the motor 128, the coupling adapter 130.4 has an extension 130.4.1, for example a disk-shaped extension, which may be provided with a number of through-openings 130.4.2. The through-openings 130.4.2 form latching mounts 134.5 of the clip connection 138.

The extension 130.4.1 is arranged coaxially with the motor shaft 128.3. The clip connection 138 between the coupling adapter 130.4 and the coupling element 130.0 forms the fourth fastening section 134.8. For the clip connection 138 or latching connection, the coupling element 130.0 comprises a number of corresponding snap hooks 134.4 matching the number of latching mounts 134.5.

The motor shaft 128.3 may be provided with a knurled profile 128.3.1. The coupling adapter 130.4 is first pushed onto and press-fitted onto the motor shaft 128.3 with the knurled profile 128.3.1. This coupling adapter 130.4 is connected to the motor shaft 128.3 in a form-fit and force-fit manner. The coupling element 130.0 is then in turn pushed onto and press-fitted onto the coupling adapter 130.4. This coupling element 130.0 is then connected to the coupling adapter 130.4 in a form-fitted and force-fitted manner.

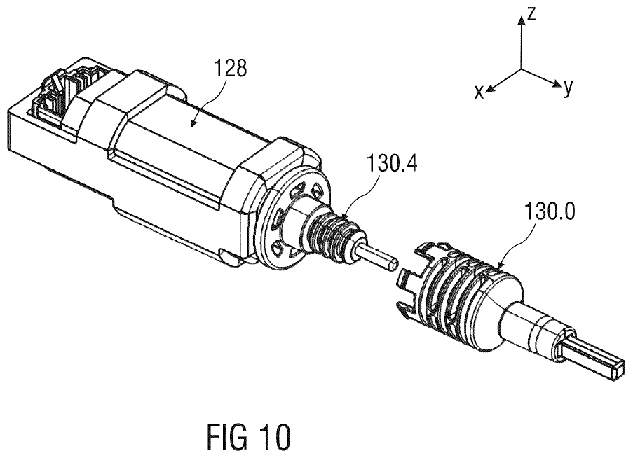

FIG. 10 schematically shows an exploded view of the motor 128 with the coupling adapter 130.4 joined and the coupling element 130.0 not yet joined.

### LIST OF REFERENCE SIGNS

100 Vehicle seat
102 Seat part
104 Backrest
106 Fitting
108 Axis of rotation
110 Longitudinal adjustment device
112 Rail arrangement
114 First rail element (upper rail)
116 Second rail element (lower rail)
120 Adjustment device
122 Armrest adjustment device
123 Armrest
124 Backrest adjustment device
126 Motor adapter
126.1 Motor mount
126.1.1 First mount opening
126.2 Coupling mount
126.2.1 Second mount opening
126.3 Stiffening section
128 Motor
128.1 Motor housing
128.2 Motor connector
128.3 Motor shaft
128.3.1 Knurled profile
130 Coupling
130.0 Coupling element
130.1 Coupling interface
130.1.1 Base section
130.1.2 Coupling section
130.2 Web
130.3 Ring disk
130.4 Coupling adapter
130.4.1 Extension
130.4.2 Through-opening
130.4.3 Hollow cylindrical section
130.4.4 Fin
130.5 Cavity
132 Damping section
134 Fastening section
134.1 First fastening section
134.2 Second fastening section
134.3 Third fastening section
134.4 Latching hook
134.5 Latching mount
134.6 Rivet
134.7 Rivet mount
134.8 Fourth fastening section
136 Gearbox
138 Clip connection
140 Support structure
140.1 Connection interface
140.2 Reinforcement profile
Assembly module 142
x Longitudinal direction
y Transverse direction
Z Vertical direction

What is claimed is:

1. A motor adapter comprising, on the one hand, a motor mount and, on the other hand, a coupling mount,
wherein the motor mount is configured as a first mount opening which is designed to receive a motor and to hold the motor releasably in a form-fit and/or force-fit manner, and
wherein the coupling mount adjoins the motor mount and is configured as a second mount opening which is designed to receive a coupling and to hold it releasably in a form-fit and/or force-fit manner, and
wherein the coupling is joined directly to the motor.

2. The motor adapter as claimed in claim 1, wherein the coupling is joined directly to the motor by a form-fit, force-fit, and/or a material bond.

3. The motor adapter as claimed in claim 1, wherein the coupling is joined directly to a motor shaft of the motor.

4. The motor adapter as claimed in claim 3, wherein the coupling is joined directly to the motor shaft in a pluggable, press-fittable, interference-fittable or compression-fittable manner.

5. The motor adapter as claimed in claim 1, wherein the coupling is designed as a compensation coupling.

6. The motor adapter as claimed in claim 1, wherein the coupling comprises a coupling adapter and a coupling element.

7. The motor adapter as claimed in claim 6, wherein the coupling element is joined directly to the coupling adapter.

8. The motor adapter as claimed in claim 6, wherein the coupling adapter is joined directly to the motor shaft.

9. The motor adapter as claimed in claim 1, wherein the motor and the coupling are pre-assembled or pre-assemblable as a mounting assembly.

10. An adjustment device for a vehicle seat comprising a motor adapter as claimed in claim 1.

11. A vehicle seat comprising an adjustment device for a vehicle seat and a motor adapter as claimed in claim 1.
